(19) United States
(12) Patent Application Publication
(10) Pub. No.: US 2025/0383757 A1
(43) Pub. Date: Dec. 18, 2025

(54) MAP DISPLAY METHOD AND APPARATUS, TERMINAL, AND STORAGE MEDIUM

(71) Applicant: TENCENT TECHNOLOGY (SHENZHEN) COMPANY LIMITED, Shenzhen (CN)

(72) Inventors: Rui HU, Shenzhen (CN); Jiayin ZHANG, Shenzhen (CN)

(73) Assignee: TENCENT TECHNOLOGY (SHENZHEN) COMPANY LIMITED, Shenzhen (CN)

(21) Appl. No.: 19/303,827

(22) Filed: Aug. 19, 2025

Related U.S. Application Data
(63) Continuation of application No. PCT/CN2024/095712, filed on May 28, 2024.

(30) Foreign Application Priority Data
Jul. 28, 2023 (CN) 202310949221.2

(51) Int. Cl. G06F 3/0483; G01C 21/36; G06F 3/0482; G06F 3/04845

(52) U.S. Cl. CPC G06F 3/0483; G01C 21/367; G06F 3/0482; G06F 3/04845; G06F 2203/04806

(57) ABSTRACT

A map display method, apparatus, and computer-readable storage medium for intelligently displaying location screening tabs in map navigation applications. The method displays a main interface of a map navigation application with a map areal view, and identifies predefined user deep browsing behaviors as tab bar wake-up events. Based on these wake-up events, a tab bar comprising candidate tabs configured to screen locations is displayed on the main interface. A target tab is determined based on user selection operations on the tab bar, and target locations matching the selected tab are presented in the map areal view. This approach enables context-aware interface elements that appear based on user interaction patterns, improving navigation efficiency and user experience.

### CROSS-REFERENCE TO RELATED APPLICATIONS

This application is a continuation application of International Application No. PCT/CN2024/095712 filed on May 28, 2024 which claims priority to Chinese Patent Application No. 202310949221.2, filed with the China National Intellectual Property Administration on Jul. 28, 2023, the disclosures of each being incorporated by reference herein in their entireties.

### FIELD

The disclosure relates to the field of computers, a map display method and apparatus, a terminal, and a storage medium.

### BACKGROUND

Map navigation applications can provide real-time map data and a navigation function, helping users search for locations and plan routes, and providing traffic information to guide the users to arrive at a destination.

In the related art, users can collect some places by using a collection function of a map navigation application. In this way, they can open a collection list when needed, select a needed place from the collection list, and mark and display the selected place on a map provided by the map navigation application.

However, current location marking implemented by using the collection function relies on manual collection and manual display triggering by users, causing low operation efficiency.

### SUMMARY

Provided are a map display method and apparatus, a device, a storage medium, and a program product, which can implement intelligent tab bar display and location screening through user behavior recognition in map navigation applications.

According to some embodiments, a map display method, performed by a computer device, includes: displaying a main interface of a map navigation application; displaying a map areal view of a map on the main interface; identifying a predefined user deep browsing behavior for the map areal view that serves as a tab bar wake-up event; displaying, based on the tab bar wake-up event, a tab bar on the main interface, the tab bar comprising at least one candidate tab configured to screen locations; determining, based on a selection operation on the tab bar, a target tab in the tab bar; and presenting a target location matching the target tab in the map areal view.

According to some embodiments, a map display apparatus, includes: at least one memory configured to store program code; and at least one processor configured to read the program code and operate as instructed by the program code, the program code including: interface displaying code configured to cause at least one of the at least one processor to display a main interface of a map navigation application; view displaying code configured to cause at least one of the at least one processor to display a map areal view of a map on the main interface; identifying code configured to cause at least one of the at least one processor to identify a predefined user deep browsing behavior for the map areal view that serves as a tab bar wake-up event; tab bar displaying code configured to cause at least one of the at least one processor to display, based on the tab bar wake-up event, a tab bar on the main interface, the tab bar comprising at least one candidate tab configured to screen locations; determining code configured to cause at least one of the at least one processor to determine, based on a selection operation on the tab bar, a target tab in the tab bar; and presenting code configured to cause at least one of the at least one processor to present a target location matching the target tab in the map areal view.

According to some embodiments, a non-transitory computer-readable storage medium, storing computer code which, when executed by at least one processor, causes the at least one processor to at least: display a main interface of a map navigation application; display a map areal view of a map on the main interface; identify a predefined user deep browsing behavior for the map areal view as a tab bar wake-up event; display, based on the tab bar wake-up event, a tab bar on the main interface, the tab bar comprising at least one candidate tab configured to screen locations; determine, based on a selection operation on the tab bar, a target tab in the tab bar; and present a target location matching the target tab in the map areal view.

### BRIEF DESCRIPTION OF THE DRAWINGS

To describe the technical solutions in some embodiments or the conventional technology more clearly, the following briefly describes the accompanying drawings required for describing embodiments or the conventional technology. Apparently, the accompanying drawings in the following descriptions are merely some embodiments, and a person of ordinary skill in the art may still derive other accompanying drawings from the disclosed accompanying drawings without creative efforts.

FIG. 1 is a schematic diagram of a scenario of a map display method according to some embodiments.

FIG. 2 is a schematic flowchart of a map display method according to some embodiments.

FIG. 3 is a schematic diagram of a position identifier of a map display method according to some embodiments.

FIG. 4 is a schematic diagram of detailed information of a map display method according to some embodiments.

FIG. 5 is a schematic diagram of detailed information of a map display method according to some embodiments.

FIG. 6 is a schematic diagram of a default main interface of a map display method according to some embodiments.

FIG. 7 is a schematic diagram of a tab bar of a map display method according to some embodiments.

FIG. 8 is a schematic full-screen diagram of a map display method according to some embodiments.

FIG. 9 is a schematic diagram of map zooming of a map display method according to some embodiments.

FIG. 10 is a schematic diagram of a tab of a map display method according to some embodiments.

FIG. 11 is a schematic diagram of target location presentation of a map display method according to some embodiments.

FIG. 12 is a schematic diagram of target location detailed information of a map display method according to some embodiments.

FIG. 13 is a schematic flowchart of system interaction of a map display method being applied to a map navigation application scenario according to some embodiments.

FIG. 14 is a schematic structural diagram of a map display apparatus according to some embodiments.

FIG. 15 is a schematic structural diagram of a terminal according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments provide a map display method and apparatus, a terminal, and a storage medium.

The map display apparatus may be integrated into an electronic device, and the electronic device may be a terminal, a server, or another device. The terminal may be a device such as a mobile phone, a tablet computer, a smart Bluetooth device, a notebook computer, or a personal computer (PC). The server may be a single server, or may be a server cluster including a plurality of servers.

In some embodiments, the map display apparatus may alternatively be integrated into a plurality of electronic devices. For example, the map display apparatus may be integrated into a plurality of servers, and the plurality of servers implement the map display method.

In some embodiments, this solution may be applied to an on board scenario, where the electronic devices include, but are not limited to, a smartphone, a computer, an intelligent voice interaction device, a smartwatch, an intelligent household appliance, an on board terminal, AR glasses, a head-mounted display device, an aircraft, and the like.

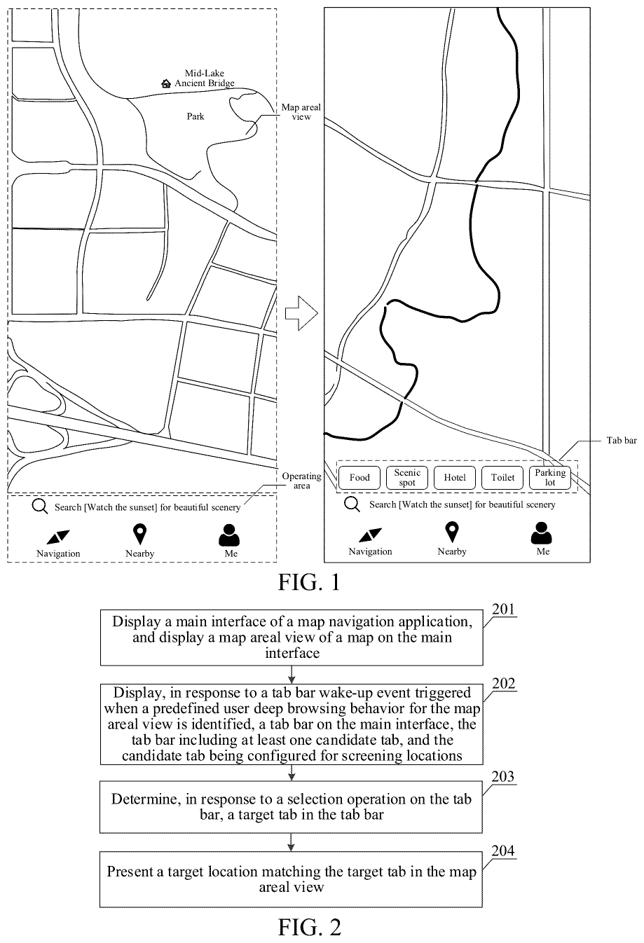

For example, refer to FIG. 1, the electronic device may display a main interface of a map navigation application. The main interface includes a map areal view and an operation area. The map areal view of a map is displayed on the main interface. In response to a tab bar wake-up event, for example, tapping on a map or moving a map, triggered when a predefined user deep browsing behavior for the map areal view is identified, a tab bar is displayed on the main interface, the tab bar including at least one candidate tab, for example, a tab such as a food, a scenic spot, a hotel, a toilet, or a parking lot, and the candidate tab being configured for screening locations. In response to a selection operation on the tab bar, a target tab is determined in the tab bar. A target location matching the target tab is presented in the map areal view. Detailed descriptions are separately provided below. Sequence numbers of the following embodiments are not intended to limit preference orders of embodiments.

A map display method is provided in some embodiments. As shown in FIG. 2, a procedure of the map display method may be as follows:

201: Display a main interface of a map navigation application, and display a map areal view of a map on the main interface.

The main interface may be a start page for a user to interact with a map-based navigation function provided by the map navigation application. The main interface may include the map areal view. The map areal view is a view formed by an area currently displayed on the map. The electronic device may obtain, in response to a scale zooming operation on the map, different map areal views, where scales of the different map areal views are different. The electronic device may further obtain, in response to a translation operation, a new map areal view in the map. A distance between the new map areal view and the map areal view before the translation operation may be equal to a translation distance obtained in the translation operation. The scale zooming operation may be implemented by using gesture zooming, a virtual key, a physical key, or a somatosensory operation. The translation operation may be implemented by using a drag operation, a virtual key, a physical key, or a somatosensory operation.

In some embodiments, the map may further present a location identifier, such as a point of interest (POI), for example, a restaurant, a hotel, or a park. These marks may be represented by using icons or tabs, to help the user find a location that the user is interested in on the map.

In some embodiments, the main interface may further include an operating area. The operating area may include a plurality of interface elements, and may include a plurality of interaction controls, where each interaction control may be configured for interaction. The interaction controls may include an interaction control configured for triggering a function, entering a new interface, or inputting information. The interaction controls are, for example, a position button, a search bar, a navigation entrance, or a setting button.

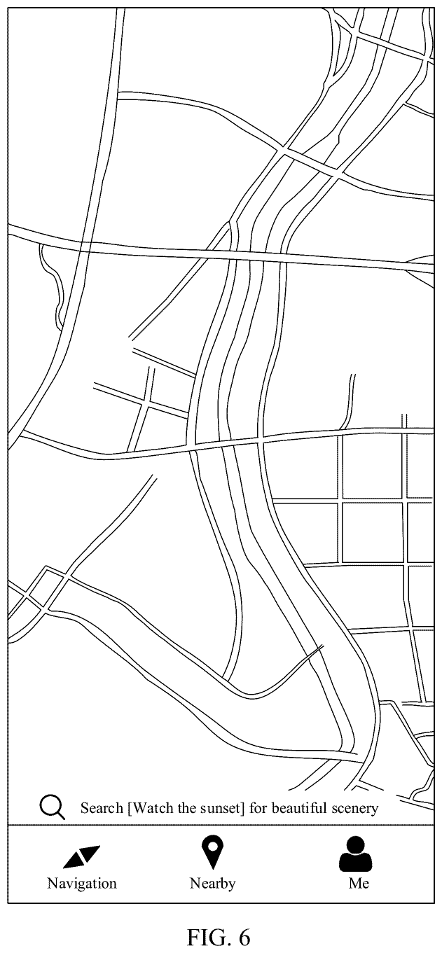

For example, refer to FIG. 6, the main interface includes the map areal view, and may also include a search bar, a navigation entrance (for example, a location marked by a word “Navigation”), a nearby location search entrance (for example, a location marked by a word “Nearby”), a user setting button (for example, a location marked by a word “Me”), and the like.

202: Display, in response to a tab bar wake-up event triggered when a predefined user deep browsing behavior for the map areal view is identified, a tab bar on the main interface, the tab bar including at least one candidate tab, and the candidate tab being configured for screening locations.

In some embodiments, the tab bar wake-up event is an event configured for waking up the tab bar. The event is triggered when the electronic device identifies the user deep browsing behavior. The user deep browsing behavior is a predefined behavior, representing that after executing a deep browsing behavior, the user has an intention of further browsing the map.

In some embodiments, when it is detected that the user performs the user deep browsing behavior on the map, the tab bar wake-up event may be generated. The user deep browsing behavior of the user may be a behavior that the user browses and explores the map areal view in detail or comprehensively in a map application, and usually indicates that the user is interested in the map areal view, and expects to obtain more details and information.

The user deep browsing behavior may include a trigger operation on a location identifier on the map. Therefore, in some embodiments, the location identifier is displayed on the map. The displaying, in response to a tab bar wake-up event triggered when a predefined user deep browsing behavior for the map areal view is identified, a tab bar on the main interface includes: triggering, in response to identification of a trigger operation that is predefined as the user deep browsing behavior and performed by a user on the location identifier, the tab bar wake-up event; and displaying, in response to the tab bar wake-up event, the tab bar on the main interface.

In some embodiments, the trigger operation performed by the user on the location identifier is used as the user deep browsing behavior in advance, and it is determined that the user intends to further browse the map after performing the trigger operation performed on the location identifier. In this case, the tab bar is automatically displayed on the main interface for the user to screen locations, thereby simplifying user operations and improving operation efficiency.

The user deep browsing behavior includes that the user taps on a point of interest mark or a region, to obtain more detailed information. Therefore, in some embodiments, in response to the trigger operation for the location identifier, in addition to displaying the tab bar on the main interface, the method further includes: obtaining detailed information of the location identifier; and displaying detailed information of the location identifier on the main interface. In some embodiments, it is determined that after performing the trigger operation on the location identifier, the user intends to further browse the map. In this case, the detailed information of the location identifier is automatically provided to the user, helping the user screen locations as soon as possible, thereby further improving operation efficiency.

The detailed information of the location identifier may include a name, an address, contact information, a popularity ranking, and the like of a location corresponding to the location identifier.

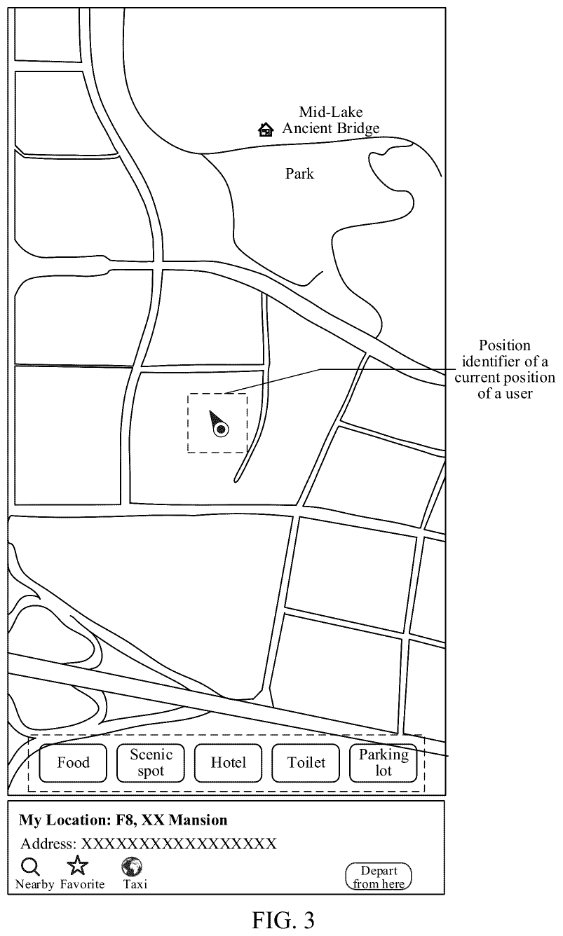

In some embodiments, the location identifier may further include a position identifier of a current position of the user. For example, refer to FIG. 3, when the position identifier of the current position of the user is triggered, detailed information, such as navigation information, of the current position of the user may be presented on the main interface.

In some embodiments, the trigger operation may include a first trigger operation and a second trigger operation, the detailed information includes first detailed information and second detailed information. The displaying detailed information of the location identifier on the main interface includes: displaying, when the trigger operation is the first trigger operation, the first detailed information and the second detailed information of the location identifier on the main interface; and displaying, when the trigger operation is the second trigger operation, the first detailed information of the location identifier on the main interface.

To further improve flexibility and functionality, different operations correspondingly display different information. For example, the first trigger operation and the second trigger operation are different operations, the first trigger operation may be a tap operation, and the second trigger operation may be a long-press operation. The first detailed information and the second detailed information may be different types of detailed information. For example, the first detailed information may be navigation detailed information, configured for providing location information of a location, such as an address, a relative distance, and a house number. The second detailed information may be consumption detailed information, configured for providing consumption information of the location, such as a ticket price, a per capita consumption price, a promotion activity, guest evaluation, guest rating, or a guest comment. In some embodiments, different trigger operations may trigger displaying of different detailed information, which helps the user select, based on a situation of the user, detailed information that may be presented, and helps the user to screen locations as soon as possible, thereby further improving operation efficiency.

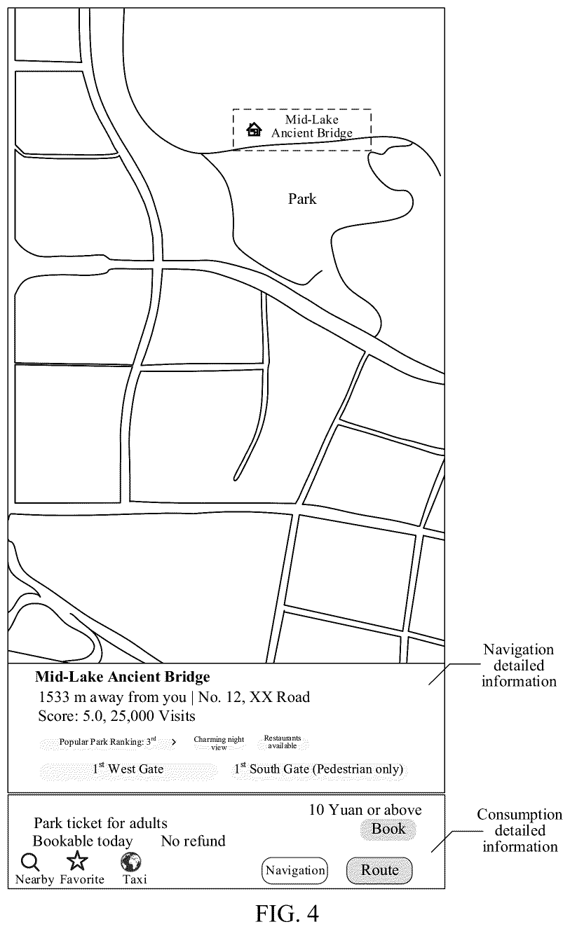

For example, refer to FIG. 4, when the trigger operation is a tap operation, the navigation detailed information and the consumption detailed information of the location identifier are displayed on the main interface. In other words, when the user taps a location identifier “Mid-Lake Ancient Bridge”, navigation detailed information and consumption detailed information of the Mid-Lake Ancient Bridge are presented.

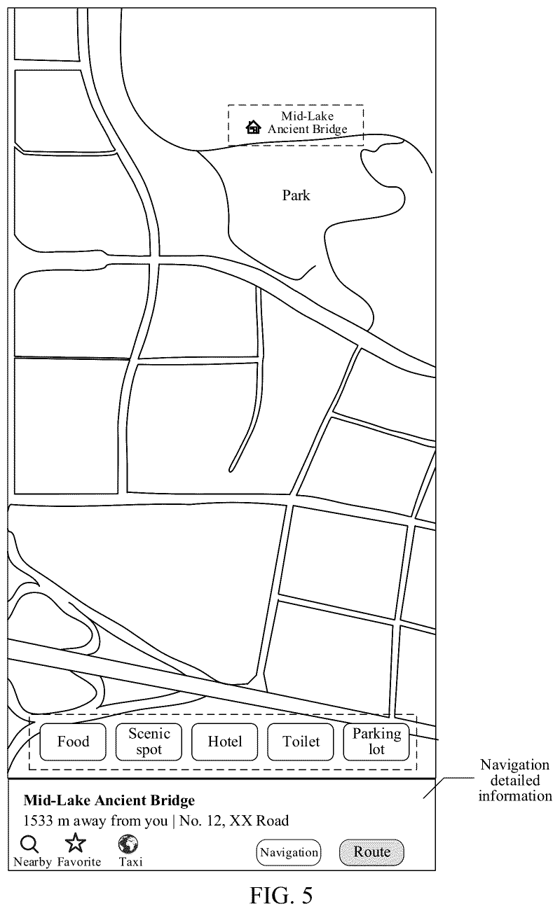

For example, refer to FIG. 5, when the trigger operation is the long-press operation, only the navigation detailed information of the location identifier is displayed on the main interface. In other words, when the user long presses the location identifier “Mid-Lake Ancient Bridge”, only the navigation detailed information of the Mid-Lake Ancient Bridge is presented.

In some embodiments, the tab bar includes a candidate tab, and the candidate tab may be obtained from preset tabs. The preset tabs may be sorted according to a preset rule, and a preset tab whose sorting number does not exceed a preset value is used as the candidate tab. Sorting numbers are sorting positions of the preset tabs in a sorted sequence after the preset tabs are sorted. For example, a sorting number in the first position is 1, a sorting number in the second position is 2, and so forth.

In some embodiments, the tab bar wake-up event may be triggered by an operation performed by the user on the map areal view, for example, moving the map areal view of the map, zooming in/out the map, or rotating the map. Therefore, operation 202 may further include: triggering, in response to identification of a viewing operation that is predefined as the user deep browsing behavior and targeted at the map, the tab bar wake-up event; and displaying, in response to the tab bar wake-up event, the tab bar on the main interface. The viewing operation includes, but is not limited to, a zoom operation, a rotation operation, a movement operation, or a full-screen operation.

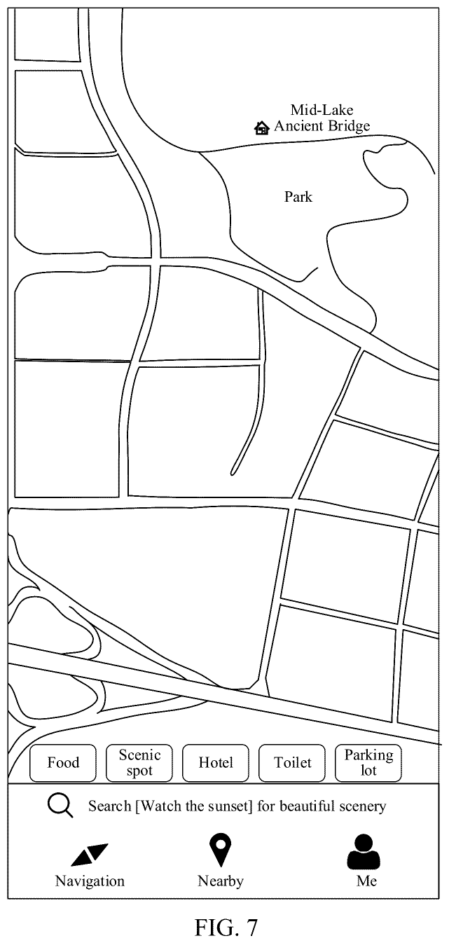

For example, refer to FIG. 6 and FIG. 7, the main interface is as shown in FIG. 6 by default. After the user drags the map to move the map areal view of the map, refer to FIG. 7, the tab bar is woken up and presented on the main interface.

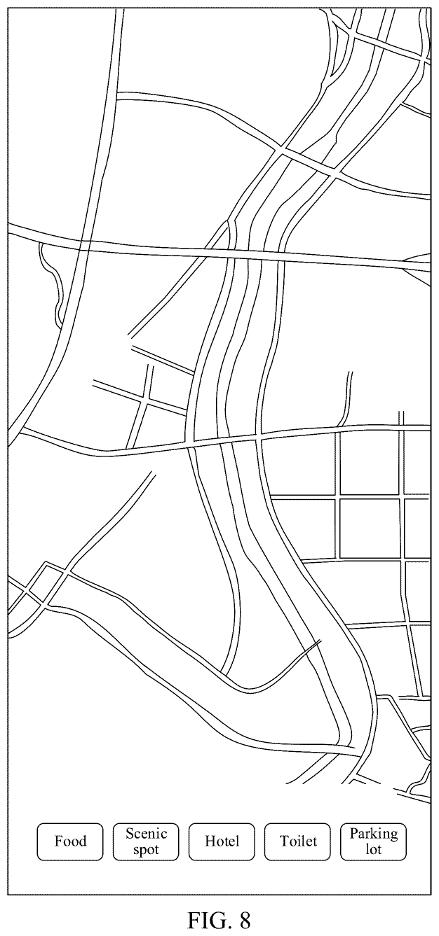

For example, refer to FIG. 6 and FIG. 8, the main interface is as shown in FIG. 6 by default. When the user lightly taps on the map, the main interface may be enabled to enter a full-screen state as shown in FIG. 8. The map areal view of the map displayed in the main interface in the full-screen state provides more information than the map areal view not in the full-screen state. In addition, some or all interface elements on the main interface other than the map may be hidden.

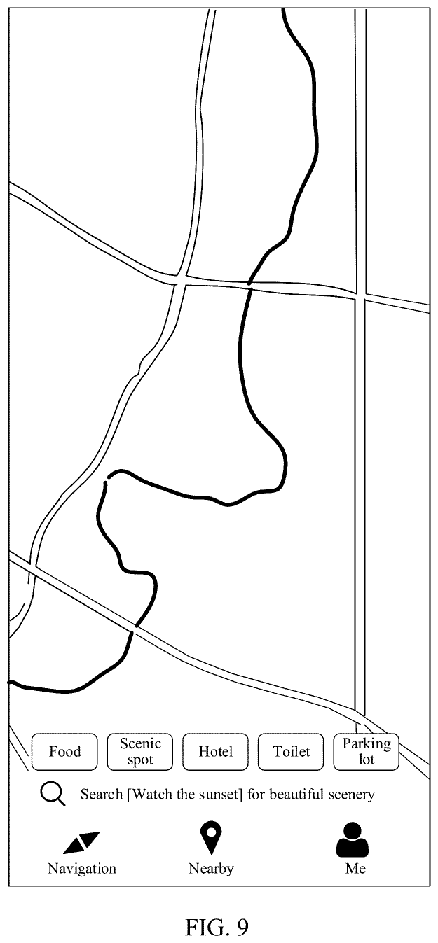

For example, refer to FIG. 6 and FIG. 9, the main interface is as shown in FIG. 6 by default. When the user zooms in/out the map, and the zoomed-in/out map is as shown in FIG. 9, the tab bar is woken up and presented on the main interface.

In some embodiments, the user deep browsing behavior may alternatively be zooming the map to a scale. Therefore, operation 202 may further include: triggering, in response to identification of a behavior of zooming a scale of the map to within a preset range that is predefined as the user deep browsing behavior, the tab bar wake-up event; and displaying, in response to the tab bar wake-up event, the tab bar on the main interface.

For example, the preset range may be set to 1:100 m to 1:1000 m, and the tab bar wake-up event is generated when the scale of the map is 1:100 m to 1:1000 m.

For example, the preset range may be set to 1:100 m to ∞, and the tab bar wake-up event is generated when the scale of the map is not less than 1:100 m to 1:1000 m.

In some embodiments, the behavior that the user zooms the scale of the map to within the preset range is predefined as the user deep browsing behavior, and it is determined that the user intends to further browse the map when zooming the scale of the map to within the preset range. In this case, the tab bar is automatically displayed on the main interface for the user to screen locations, thereby simplifying user operations and improving operation efficiency.

In some embodiments, the tab bar wake-up event may be detected based on an idle behavior of the user. Therefore, operation 202 may further include: triggering, in response to identification of a behavior that is predefined as the user deep browsing behavior and the user does not perform any operation on the map within preset duration, the tab bar wake-up event; and displaying, in response to the tab bar wake-up event, the tab bar on the main interface. In some embodiments, the behavior that the user does not perform any operation on the map within the preset duration is predefined as the user deep browsing behavior, and it is determined that the user pays attention to the map for at least the preset duration when the user does not perform any operation on the map within the preset duration. Therefore, it may be determined that the user intends to further browse the map. In this case, the tab bar is automatically displayed on the main interface for the user to screen locations, thereby simplifying user operations and improving operation efficiency.

In some embodiments, a quantity of preset tabs may be multiple, and only a quantity of tabs that are most appropriate are selected from the tab bar as the candidate tabs. Therefore, before displaying the tab bar on the main interface, the tab bar including at least one candidate tab, the method further includes: determining a tab recommendation parameter; and determining the candidate tab in a preset tab set based on the tab recommendation parameter. In some embodiments, the candidate tab is determined in the preset tab set by using the tab recommendation parameter. In this way, the candidate tab can be accurately determined, and a candidate tab that better matches the user is provided for the user, to avoid a situation in which the user needs to further search for a location manually because the user cannot find a suitable candidate tab, thereby improving operation efficiency.

The recommendation parameter is a reference parameter for recommending a tab to the user, and may include a user preference, a region preference, a region type, or the like. The user preference refers to a preference of the user about tab selection. The region preference refers to a preference of other users about tab selection in the map areal view. The region type refers to a type of a geographical area in the map areal view, for example, a hospital area, a scenic spot area, or a snack street area.

For example, if the user often selects a food tab recently, it can be known that the user prefers to search for a food location, and the food tab is used as the candidate tab. Therefore, in some embodiments, the tab recommendation parameter includes the user preference, and determining the tab recommendation parameter includes: obtaining a tab selection historical record of the user; and performing preference statistics on the tab selection historical record of the user, to obtain a user preference of the user. In some embodiments, the preference statistics can be accurately performed by using the tab selection historical record of the user, to accurately determine the user preference, and a candidate tab that better matches the user can be provided for the user, to avoid a situation in which the user needs to further search for a location manually because the user cannot find an appropriate candidate tab, thereby improving operation efficiency.

For example, the user selects a food tab for 6 times, a scenic spot tab for 3 times, and a parking lot tab for 1 time in the past week, and a user preference [food 7 times, scenic spot 3 times, parking lot 3 times, hotel 0 time, toilet 0 time, hospital 0 time, express station 0 time . . . ] is obtained after statistics collection. Based on the user preference, the first k tabs may be displayed in the tab bar, for example, the food tab, the scenic spot tab, and the parking lot tab are displayed. In some embodiments, the first k tabs may be presented in the tab bar in descending order based on a preference value for each tab in the user preference, where k is a positive integer.

Similarly, if a tab usually searched by other users in the map areal view is the parking lot tab, the parking lot tab is used as the candidate tab. Therefore, in some embodiments, the tab recommendation parameter includes the region preference, and the determining the tab recommendation parameter includes: determining all locations in the map areal view on the map; obtaining tab selection historical records of all locations in the map areal view; and performing preference statistics on the tab selection historical records of all locations in the map areal view, to determine a region preference of the map areal view.

For example, each time another user selects a tab, a location matching the tab is recorded, to obtain a tab selection historical record of a tab corresponding to each location. For example, the map areal view includes only two locations: a location [Delicious Hot Pot Restaurant], whose selection historical record within a week is [being selected for 54 times as a restaurant tab, 40 times as a hot pot tab, 0 time as a scenic spot tab, 0 time as a hotel tab . . . ]; and a location [Region 2 Style Restaurant], whose selection historical record within a week is [being selected for 130 times as a restaurant tab, 88 times as a region 2 style restaurant tab, 0 time as a scenic spot tab, 0 time as a hotel tab . . . ]. By adding and collecting statistics on each tab selection historical record of all locations in the map areal view, [being selected for 130 times as a restaurant tab, 88 times as a region 2 style restaurant tab, 40 times as a hot pot tab, 0 time as a scenic spot tab, 0 time as a hotel tab . . . ] is obtained. In some embodiments, the first k tabs may be presented in the tab bar in descending order based on a preference value for each tab in the region preference, where k is a positive integer.

For example, if a plurality of hospitals exist in the map areal view, a hospital tab may be used as the candidate tab. Therefore, in some embodiments, the tab recommendation parameter includes the region type, and the determining the tab recommendation parameter includes: determining all locations in the map areal view on the map and a tab matching each location; and determining a region type of the map areal view based on the tab matching each location.

For example, there are 15 restaurants, 10 scenic spots, 1 pharmacy, and 3 parking lots in the map areal view, and each location matches a corresponding tab, for example, a restaurant matches a restaurant tab, and a scenic spot matches a scenic spot tab. Therefore, in some embodiments, based on the tabs, the first k tabs with the highest quantities in the map areal view may be obtained, and the first k tabs are presented in the tab bar in descending order, where k is a positive integer.

In some embodiments, the candidate tabs in the tab bar may alternatively be sorted based on retrieval popularity. For example, retrieval popularity in the latest week ranks food, scenic spots, hotels, toilets, and parking lots. Therefore, the candidate tabs may be sorted based on popularity.

In some embodiments, a function of not hiding the tab bar may be provided for a user who frequently uses the tab bar. In other words, for an active retrieval user, the tab bar does not need to be displayed on the main interface based on the tab bar wake-up event, but may be always displayed on the main interface for the user. Therefore, operation 202 includes: obtaining a tab selection historical record of the user; and determining a user type based on the tab selection historical record of the user. When the user type is the active retrieval type, the tab bar is displayed on the main interface. In some embodiments, users are sorted by user types. When the user type is the active retrieval type, it indicates that the user is usually in a state of performing a user deep browsing behavior. In this case, the tab bar may be automatically displayed on the main interface, thereby further improving operation efficiency.

In some embodiments, after a tab bar is displayed for preset duration, the electronic device may hide the tab bar, or may hide the tab bar when determining that a user browsing behavior ends.

203: Determine, in response to a selection operation on the tab bar, a target tab in the tab bar.

In some embodiments, a plurality of sub-tabs may be associated with each tab, and a sub-tab is a detailed category of a tab. For example, sub-tabs associated with a restaurant tab may include a region 1 style restaurant sub-tab, a region 2 style restaurant sub-tab, a region 3 style restaurant sub-tab, and the like. Therefore, in some embodiments, a sub-tab under a tab may be determined as a target tab, to implement more detailed screening and querying.

In some embodiments, as each tab is associated with a plurality of sub-tabs. displaying the plurality of sub-tabs associated with each tab on the main interface may cause a problem of excessive interface elements. Therefore, a secondary operation may be performed to reduce interface elements. In other words, the user first selects one of a plurality of tabs, and the main interface presents a sub-tab associated with the selected tab, so that the user can selects a target tab therefrom.

In some embodiments, the determining, in response to a selection operation on the tab bar, a target tab in the tab bar includes: determining, in response to a selection operation on the candidate tab, the candidate tab as the target tab; displaying, in response to a sub-tab bar wake-up event of the candidate tab, at least one candidate sub-tab corresponding to the candidate tab in the tab bar; and determining, in response to a selection operation on the candidate sub-tab, the candidate sub-tab as the target tab. Operations are simple in this manner, and operation efficiency can be further improved.

The sub-tab bar wake-up event may include long-pressing the candidate tab, double-tapping on the candidate tab, tapping on the candidate tab, dragging the candidate tab, sliding the candidate tab, or the like.

In some embodiments, the candidate tab may include a sub-tab wake-up region and a selection region. The user triggers the sub-tab wake-up region to generate the sub-tab bar wake-up event, and the user triggers the selection region to determine the candidate tab as the target tab.

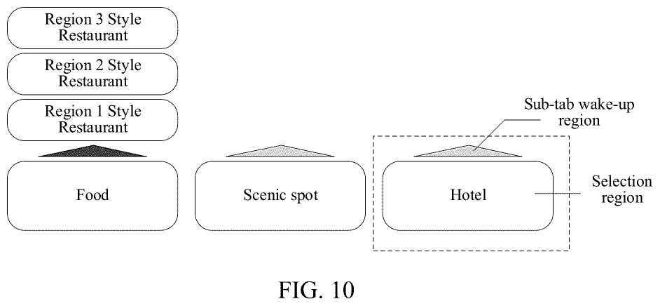

For example, refer to FIG. 10, the tab bar includes three candidate tabs: a food tab, a scenic spot tab, and a hotel tab. Each candidate tab is divided into a selection region and a sub-tab wake-up region. When the sub-tab wake-up region of the food tab is tapped on, a sub-tab associated with the food tab may be displayed above the food tab, for example, a region 1 style restaurant sub-tab, a region 2 style restaurant sub-tab, and a region 3 style restaurant sub-tab.

204: Present a target location matching the target tab in the map areal view.

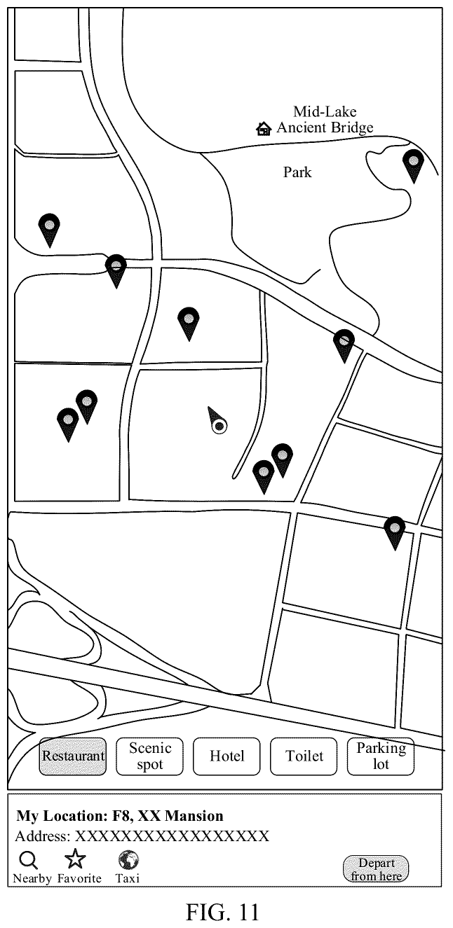

For example, refer to FIG. 11, when the user selects the [Food] tab as the target tab, all target locations matching the target tab in the map areal view are presented in the map areal view.

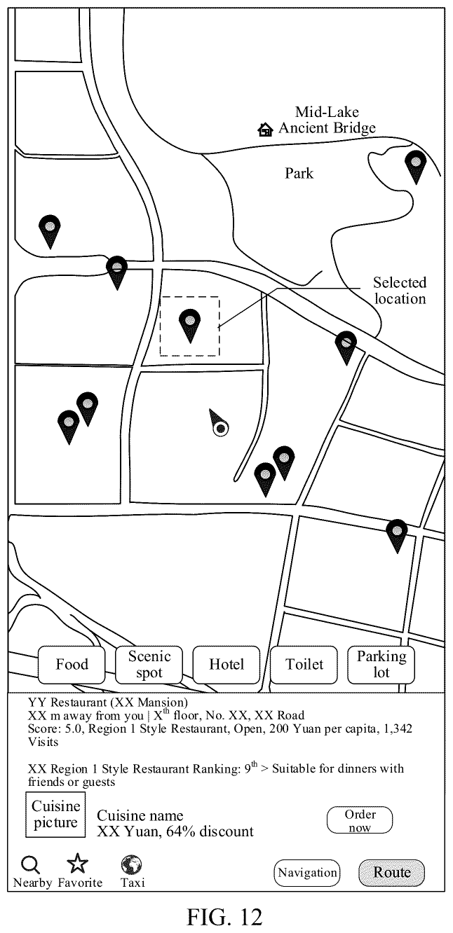

In some embodiments, refer to FIG. 12, the user may select any target location matching the target tab and presented in the map as a selected location, so that the main interface displays detailed information of the selected location.

In some embodiments, when the user selects a plurality of target tabs from the candidate tabs, target locations corresponding to the target tabs may be all presented on the map.

It can be learned from the foregoing that, some embodiments can: display a main interface of a map navigation application, and display a map areal view of a map on the main interface; in response to a tab bar wake-up event triggered when a predefined user deep browsing behavior for the map areal view is identified, display a tab bar on the main interface, the tab bar including at least one candidate tab, and the candidate tab being configured for screening locations; in response to a selection operation on the tab bar, determine a target tab in the tab bar; and present a target location matching the target tab in the map areal view.

Therefore, in some embodiments, the user deep browsing behavior of a user on the main interface can be perceived, so that the tab bar is provided on the main interface for quick retrieval by the user when the user needs the tab bar. The tab bar is displayed only when the user performs deep browsing on the main interface, and the tab bar is hidden at other times for simplicity of map display. In addition, providing the tab bar on the main interface can effectively reduce retrieval complexity, thereby implementing a continuous and high-efficient process in which the user browses the map and retrieves a location by “deep browsing”-“retrieving”-“obtaining a result quickly”-“continuing to browse” on the main interface, and improving operation efficiency.

According to the method described in the foregoing embodiment, the following further provides detailed descriptions by using an example.

In some embodiments, a map application system is used as an example to describe the method in detail in some embodiments.

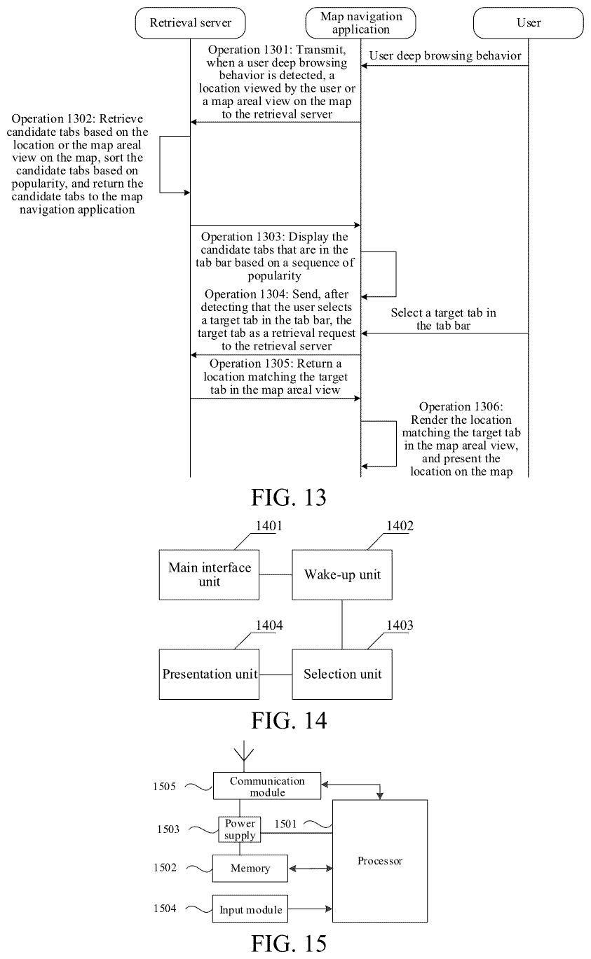

As shown in FIG. 13, the map application system includes a map navigation application and a retrieval server. A procedure of a map display method is as follows:

1301: The map navigation application transmits, when the map navigation application detects a user deep browsing behavior, a location viewed by the user or a map areal view on the map to the retrieval server.

The user deep browsing behavior may be classified into a viewing operation on the map, such as zooming, rotating, moving, or setting the map to full screen, and an operation on a location identifier on the map, such as tapping, double-tapping, or long-pressing the location identifier. The location identifier may include an identifier of a location on the map, or may include a position identifier of a current position of the user on the map.

1302: The retrieval server retrieves candidate tabs based on the location or the map areal view on the map, sorts the candidate tabs based on popularity, and returns the candidate tabs to the map navigation application.

For example, tab popularity of all locations in the map areal view on the map may be counted and sorted, and a sorting result is returned to the map navigation application.

1303: The map navigation application displays the candidate tags that are in the tab bar based on a sequence of popularity.

For example, the first N tags may be used as candidate tabs according to popularity ranking, where N is a positive integer.

For example, the candidate tabs in the tab bar may be displayed in the tab bar based on a sequence of popularity.

1304: After detecting that the user selects a target tab in the tab bar, the map navigation application sends the target tab as a retrieval request to the retrieval server.

1305: The retrieval server returns a location matching the target tab in the map areal view to the map navigation application.

1306: The map navigation application renders the location matching the target tab in the map areal view, and presents the location on the map.

For example, the target location may be highlighted.

In some embodiments, if the user moves, zooms, and rotates the map after operation 1306, perform operation 1302, for example, return a new map areal view to the retrieval server, to quickly display the target location in the new map areal view.

This solution is applied to a main interface of a map navigation application, and may also be applied to another page of the map navigation application, such as a navigation page and a traffic condition page. In addition, the map navigation application may be a native application, a web application, or a sub-application, where the sub-application may be run in a running environment provided by a parent application, and the parent application may be run on an operating system.

As the user has a demand for retrieving information about a location of a certain type when browsing the main interface, wake-up and display of the tab bar in this usage scenario are added in some embodiments, helping the user satisfy a demand for quick retrieval in a usage scenario in which the user performs deep browsing on the main interface. In addition, a retrieval result can be directly rendered and displayed on the main interface, providing quick and consistent use experience.

Some embodiments aims to provide a quick retrieval method in a map deep browsing scenario. When the user performs a deep browsing behavior on the main interface, the wake-up and the display of the tab bar are triggered. When the user taps on a target tab in the tab bar, a target location with the target tab is intensively presented in the map areal view on the map, to support the user to quickly observe a location and location detailed information that conform to the target tab, thereby optimizing retrieval experience during map browsing.

It can be known from the foregoing that, while map display simplicity is improved, operation complexity is reduced, and operation efficiency is improved.

To better implement the foregoing method, some embodiments further provide a map display apparatus. The map display apparatus may be integrated into an electronic device, where the electronic device may be a device such as a terminal and a server. The terminal may be a device such as a mobile phone, a tablet computer, a smart Bluetooth device, a notebook computer, and a personal computer. The server may be a single server, or may be a server cluster including a plurality of servers.

For example, in some embodiments, the method in some embodiments is described in detail by using an example in which the map display apparatus is integrated into the terminal.

For example, as shown in FIG. 14, the map display apparatus may include a main interface unit 1401, a wake-up unit 1402, a selection unit 1403, and a presentation unit 1404 as follows:

### (1) Main Interface Unit 1401

The main interface unit 1401 is configured to: display a main interface of a map navigation application, and display a map areal view of a map on the main interface.

In some embodiments, the main interface unit 1401 further includes:
a parameter subunit, configured to determine a tab recommendation parameter; and
a determining subunit, configured to determine a candidate tab in a preset tab set based on the tab recommendation parameter.

In some embodiments, the tab recommendation parameter includes a user preference, and the determining subunit is configured to:
obtain a tab selection historical record of a user; and
perform preference statistics on the tab selection historical record of the user, to obtain a user preference of the user.

In some embodiments, the tab recommendation parameter includes a region preference, and the determining subunit is configured to:
determine all locations in the map areal view on the map;
obtain tab selection historical records of all locations in the map areal view; and
perform preference statistics on the tab selection historical records of all locations in the map areal view, to determine a region preference of the map areal view.

In some embodiments, the tab recommendation parameter includes a region type, and the determining subunit is configured to:
determine all the locations in the map areal view on the map and a tab matching each location; and
determine a region type of the map areal view based on the tab matching each location.

### (2) Wake-Up Unit 1402

The wake-up unit 1402 is configured to display, in response to a tab bar wake-up event triggered when a predefined user deep browsing behavior for the map areal view is identified, a tab bar on the main interface, the tab bar including at least one candidate tab, and the candidate tab being configured for screening locations.

In some embodiments, a location identifier is displayed on the map, and the wake-up unit 1402 is configured to display the tab bar on the main interface in response to a trigger operation on the location identifier.

In some embodiments, the wake-up unit 1402 further includes:
a detailed subunit, configured to obtain detailed information of the location identifier; and
a display detailed subunit, configured to display detailed information of the location identifier on the main interface.

In some embodiments, the trigger operation is divided into a first trigger operation and a second trigger operation, and the detailed information includes first detailed information and second detailed information. The display detailed subunit is configured to:
display, when the trigger operation is the first trigger operation, the first detailed information and the second detailed information of the location identifier on the main interface; and
display, when the trigger operation is the second trigger operation, the first detailed information of the location identifier on the main interface.

In some embodiments, before the wake-up unit 1402 is configured to display, in response to a tab bar wake-up event triggered when a predefined user deep browsing behavior for the map areal view is identified, a tab bar on the main interface, the wake-up unit 1402 is further configured to generate the tab bar wake-up event when detecting a viewing operation targeted on the map by the user. The viewing operation includes, but is not limited to, at least one of a zoom operation, a rotation operation, a movement operation, or a full-screen operation.

In some embodiments, before the wake-up unit 1402 is configured to display, in response to a tab bar wake-up event triggered when a predefined user deep browsing behavior for the map areal view is identified, a tab bar on the main interface, the wake-up unit 1402 is further configured to generate the tab bar wake-up event when detecting that a scale of the map is within a preset range.

In some embodiments, before the wake-up unit 1402 is configured to display, in response to a tab bar wake-up event triggered when a predefined user deep browsing behavior for the map areal view is identified, a tab bar on the main interface, the wake-up unit 1402 is further configured to generate the tab bar wake-up event when detecting that the user does not perform any operation on the map within preset duration.

### (3) Selection Unit 1403

The selection unit 1403 is configured to determine, in response to a selection operation on the tab bar, a target tab in the tab bar.

In some embodiments, the selection unit 1403 is configured to: determine, in response to a selection operation on the candidate tab, the candidate tab as the target tab; display, in response to a sub-tab bar wake-up event of the candidate tab, at least one candidate sub-tab corresponding to the candidate tab in the tab bar; and determine, in response to a selection operation on the candidate sub-tab, the candidate sub-tab as the target tab.

### (4) Presentation Unit 1404

The presentation unit 1404 is configured to present a target location matching the target tab in the map areal view.

During implementation, the foregoing units may be implemented as independent entities, or may be randomly combined, or may be implemented as a same entity or several entities. For implementation of the foregoing units, refer to the foregoing method embodiments. Details are not described herein again.

It can be learned from the foregoing that, in the map display apparatus of some embodiments, the main interface unit displays the main interface of the map navigation application, and displays the map areal view of the map on the main interface. The wake-up unit displays, in response to a tab bar wake-up event triggered when a predefined user deep browsing behavior for the map areal view is identified, a tab bar on the main interface, the tab bar including at least one candidate tab, and the candidate tab being configured for screening locations. The selection unit determines, in response to a selection operation on the tab bar, a target tab in the tab bar. The presentation unit presents a target location matching the target tab in the map areal view.

Therefore, some embodiments can reduce operation complexity while ensuring map display simplicity.

Some embodiments further provide an electronic device. The electronic device may be a device such as a terminal and a server. The terminal may be a mobile phone, a tablet computer, a smart Bluetooth device, a notebook computer, a personal computer, or the like. The server may be a single server, may be a server cluster including a plurality of servers, or the like.

In some embodiments, the map display apparatus may alternatively be integrated into a plurality of electronic devices. For example, the map display apparatus may be integrated into a plurality of servers, and the plurality of servers implement the map display method.

In some embodiments, an example in which the electronic device of some embodiments is the terminal is used for detailed descriptions. For example, as shown in FIG. 15, a schematic structural diagram of the terminal according to some embodiments is displayed. Specifically:

The terminal may include components such as a processor 1501 of one or more processing cores, a memory 1502 of one or more computer-readable storage media, a power supply 1503, an input module 1504, and a communication module 1505. A person skilled in the art may understand that a terminal structure shown in FIG. 15 constitutes no limitation to the terminal, and the terminal may include more or fewer components than those shown in the figure, or some components may be combined, or a different component deployment may be used. Herein:

The processor 1501 is a control center of the terminal, and connects to various parts of the terminal by using various interfaces and lines. By running or executing the software program and/or module stored in the memory 1502, and invoking data stored in the memory 1502, the processor 1501 performs various functions and data processing of the terminal, thereby performing overall monitoring on the terminal. In some embodiments, the processor 1501 may include one or more processing cores. In some embodiments, the processor 1501 may integrate an application processor and a modem processor. The application processor processes an operating system, an operating area, an application program, and the like. The modem processor processes wireless communication. The foregoing modem processor may either not be integrated into the processor 1501.

The memory 1502 may be configured to store a software program and module. The processor 1501 runs the software program and module stored in the memory 1502, to perform various functional applications and data processing. The memory 1502 may include a program storage area and a data storage area. The program storage area may store an operating system, an application program performed by at least one function (such as a sound playback function and an image display function), and the like. The data storage area may store data created according to use of the terminal, and the like. In addition, the memory 1502 may include a high speed random access memory, and may also include a non-volatile memory, such as at least one magnetic disk storage device, a flash memory, or another volatile solid-state memory. Correspondingly, the memory 1502 may further include a memory controller, to provide access of the processor 1501 to the memory 1502.

The terminal further includes the power supply 1503 for supplying power to the components. In some embodiments, the power supply 1503 may be logically connected to the processor 1501 by using a power supply management system, thereby implementing functions, such as charging, discharging, and power consumption management, by using the power supply management system. The power supply 1503 may further include one or more of a direct current or alternating current power supply, a re-charging system, a power failure detection circuit, a power supply converter or inverter, a power supply state indicator, and any other components.

The terminal may further include the input module 1504. The input module 1504 may be configured to: receive inputted numeric or character information, and generate signal input of a keyboard, a mouse, an analog stick, and an optical or trackball signal related to user settings and function control.

The terminal may further include the communication module 1505. In some embodiments, the communication module 1505 may include a wireless module. The terminal may perform short-distance wireless transmission by using the wireless module of the communication module 1505, to provide wireless broadband Internet access for a user. The communication module 1505 may be configured to help the user to receive and send e-mails, browse a webpage, access streaming media, and the like.

Although not shown in the figure, the terminal may further include a display unit, and the like. Details are not further described herein. Specifically, in some embodiments, the processor 1501 in the terminal may load, based on the following events, executable files corresponding to processes of one or more application programs into the memory 1502. The processor 1501 runs the application programs stored in the memory 1502, to perform various functions as follows: displaying a main interface of a map navigation application, and displaying a map areal view of a map on the main interface; in response to a tab bar wake-up event triggered when a predefined user deep browsing behavior for the map areal view is identified, displaying a tab bar on the main interface, the tab bar including at least one candidate tab, and the candidate tab being configured for screening locations; in response to a selection operation on the tab bar, determining a target tab in the tab bar; and presenting a target location matching the target tab in the map areal view.

For a implementation of each foregoing operation, refer to the foregoing embodiments. Details are not described herein again.

It can be known from the foregoing that, some embodiments can reduce operation complexity and improve operation efficiency while ensuring map display simplicity.

A person skilled in the art may understand that all or some operations of the methods in the foregoing embodiments may be completed through events or through hardware related to event controlling. The event may be stored in a computer-readable storage medium and loaded and executed by a processor.

Therefore, some embodiments provide a computer-readable storage medium, having a plurality of computer-readable instructions stored therein. The computer-readable instructions can be loaded by a processor, to perform the operations of any map display method provided in some embodiments. For example, when the computer-readable instructions are executed by the processor, the following operations may be implemented: displaying a main interface of a map navigation application, and displaying a map areal view of a map on the main interface; in response to a tab bar wake-up event triggered when a predefined user deep browsing behavior for the map areal view is identified, displaying a tab bar on the main interface, the tab bar including at least one candidate tab, and the candidate tab being configured for screening locations; in response to a selection operation on the tab bar, determining a target tab in the tab bar; and presenting a target location matching the target tab in the map areal view.

The storage medium may include: a read-only memory (ROM), a random access memory (RAM), a magnetic disk, an optical disc, or the like.

According to some embodiments, a computer program product or a computer program is provided. The computer program product or the computer program includes a computer event, and the computer event is stored in a computer-readable storage medium. A processor of a computer device reads the computer event from the computer-readable storage medium. The processor executes the computer instruction, to cause the computer device to perform the methods provided in the implementations in a map display aspect or a navigation aspect in the foregoing embodiments.

As the event stored in the storage medium may perform the operations of any map display method provided in some embodiments, the event can implement advantageous effects that may be implemented by any map display method provided in some embodiments. The foregoing embodiments may be referred to for details. Details are not further described herein.

The technical features in the foregoing embodiments may be randomly combined. For concise description, not all possible combinations of the technical features in the foregoing embodiments are described. However, the combinations of the technical features shall all be considered as falling within the scope described in this specification provided that they do not conflict with each other.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A map display method, performed by a computer device, the method comprising:
displaying a main interface of a map navigation application;
displaying a map areal view of a map on the main interface;
identifying a predefined user deep browsing behavior for the map areal view that serves as a tab bar wake-up event;
displaying, based on the tab bar wake-up event, a tab bar on the main interface, the tab bar comprising at least one candidate tab configured to screen locations;
determining, based on a selection operation on the tab bar, a target tab in the tab bar; and
presenting a target location matching the target tab in the map areal view.

2. The map display method according to claim 1,
wherein a location identifier is displayed on the map,
wherein the identifying a predefined user deep browsing behavior comprises:
identifying a trigger operation performed on the location identifier as the predefined user deep browsing behavior that serves as a tab bar wake-up event.

3. The map display method according to claim 2, the method further comprising:
obtaining detailed information of the location identifier; and
displaying the detailed information of the location identifier on the main interface.

4. The map display method according to claim 3,
wherein the trigger operation comprises a first trigger operation and a second trigger operation, the detailed information comprises first detailed information and second detailed information,
wherein the displaying the detailed information comprises:
displaying, based on the first trigger operation, the first detailed information and the second detailed information of the location identifier on the main interface; and
displaying, based on the second trigger operation, the first detailed information of the location identifier on the main interface.

5. The map display method according to claim 1,
wherein the identifying a predefined user deep browsing behavior comprises:
identifying a viewing operation performed on the map as the predefined user deep browsing behavior that serves as a tab bar wake-up event, the viewing operation comprising at least one of a zoom operation, a rotation operation, a movement operation, or a full-screen operation.

6. The map display method according to claim 1,
wherein the identifying a predefined user deep browsing behavior comprises:
identifying that a scale of the map is zoomed to within a preset range as the predefined user deep browsing behavior that serves as a tab bar wake-up event.

7. The map display method according to claim 1, wherein the identifying a predefined user deep browsing behavior comprises:
identifying that no operation is performed on the map within a preset duration as the predefined user deep browsing behavior that serves as a tab bar wake-up event.

8. The map display method according to claim 1,
wherein the determining a target tab comprises:
determining, based on a selection operation on a candidate tab, the candidate tab as the target tab;
displaying, based on a sub-tab bar wake-up event of the candidate tab, at least one candidate sub-tab corresponding to the candidate tab; and
determining, based on a selection operation on the at least one candidate sub-tab, the at least one candidate sub-tab as the target tab.

9. The map display method according to claim 1, before the displaying a tab bar on the main interface, the tab bar comprising at least one candidate tab, the method further comprising:
determining a tab recommendation parameter; and
determining the candidate tab in a preset tab set based on the tab recommendation parameter.

10. The map display method according to claim 9,
wherein the tab recommendation parameter comprises a user preference, and wherein the determining a tab recommendation parameter comprises:
obtaining a tab selection historical record of a user;
performing preference statistics on the tab selection historical record of the user; and
determining a user preference of the user based on the preference statistics.

11. The map display method according to claim 9,
wherein the tab recommendation parameter comprises a region preference,
wherein the determining a tab recommendation parameter comprises:
determining locations in the map areal view on the map;
obtaining tab selection historical records of the locations in the map areal view;
performing preference statistics on the tab selection historical records of the locations in the map areal view; and
determining a region preference of the map areal view based on the preference statistics.

12. The map display method according to claim 9,
wherein the tab recommendation parameter comprises a region type,
wherein the determining a tab recommendation parameter comprises:
determining locations in the map areal view on the map and a tab matching each of the locations; and
determining a region type of the map areal view based on the tab matching each of the locations.

13. A map display apparatus, comprising:
at least one memory configured to store program code; and
at least one processor configured to read the program code and operate as instructed by the program code, the program code comprising:
interface displaying code configured to cause at least one of the at least one processor to display a main interface of a map navigation application;
view displaying code configured to cause at least one of the at least one processor to display a map areal view of a map on the main interface;
identifying code configured to cause at least one of the at least one processor to identify a predefined user deep browsing behavior for the map areal view that serves as a tab bar wake-up event;
tab bar displaying code configured to cause at least one of the at least one processor to display, based on the tab bar wake-up event, a tab bar on the main interface, the tab bar comprising at least one candidate tab configured to screen locations;
determining code configured to cause at least one of the at least one processor to determine, based on a selection operation on the tab bar, a target tab in the tab bar; and
presenting code configured to cause at least one of the at least one processor to present a target location matching the target tab in the map areal view.

14. The map display apparatus according to claim 13,
wherein a location identifier is displayed on the map,
wherein the identifying code is further configured to cause at least one of the at least one processor to:
identify a trigger operation performed on the location identifier as the predefined user deep browsing behavior that serves as a tab bar wake-up event.

15. The map display apparatus according to claim 14, wherein the program code further comprises:
obtaining code configured to cause at least one of the at least one processor to obtain detailed information of the location identifier; and
information displaying code configured to cause at least one of the at least one processor to display the detailed information of the location identifier on the main interface.

16. The map display apparatus according to claim 15,
wherein the trigger operation comprises a first trigger operation and a second trigger operation, the detailed information comprises first detailed information and second detailed information,
wherein the information displaying code is further configured to cause at least one of the at least one processor to:
display, based on the first trigger operation, the first detailed information and the second detailed information of the location identifier on the main interface; and
display, based on the second trigger operation, the first detailed information of the location identifier on the main interface.

17. The map display apparatus according to claim 13,
wherein the identifying code is further configured to cause at least one of the at least one processor to:
identify a viewing operation performed on the map as the predefined user deep browsing behavior that serves as a tab bar wake-up event, the viewing operation comprising at least one of a zoom operation, a rotation operation, a movement operation, or a full-screen operation.

18. The map display apparatus according to claim 13,
wherein the identifying code is further configured to cause at least one of the at least one processor to:
identify that a scale of the map is zoomed to within a preset range as the predefined user deep browsing behavior that serves as a tab bar wake-up event.

19. The map display apparatus according to claim 13, wherein the identifying code is further configured to cause at least one of the at least one processor to:
identify that no operation is performed on the map within a preset duration as the predefined user deep browsing behavior that serves as a tab bar wake-up event.

20. A non-transitory computer-readable storage medium, storing computer code which, when executed by at least one processor, causes the at least one processor to at least:
display a main interface of a map navigation application;
display a map areal view of a map on the main interface;
identify a predefined user deep browsing behavior for the map areal view as a tab bar wake-up event;
display, based on the tab bar wake-up event, a tab bar on the main interface, the tab bar comprising at least one candidate tab configured to screen locations;
determine, based on a selection operation on the tab bar, a target tab in the tab bar; and
present a target location matching the target tab in the map areal view.
